(19) United States
(12) Patent Application Publication
(10) Pub. No.: US 2015/0318759 A1
(43) Pub. Date: Nov. 5, 2015

(54) ELECTRICAL DEVICE FOR STORING ELECTRICITY BY FLYWHEEL

(71) Applicant: LEVISYS, ROSIERES PRES TROYES (FR)

(72) Inventor: Michel SAINT MLEUX, BORMES LES MIMOSAS (FR)

(73) Assignee: LEVISYS, ROSIERES PRES TROYES (FR)

(21) Appl. No.: 14/797,641

(22) Filed: Jul. 13, 2015

Related U.S. Application Data
(63) Continuation of application No. PCT/FR2014/050068, filed on Jan. 14, 2014.

(30) Foreign Application Priority Data
Jan. 15, 2013 (FR) 13/50336

(51) Int. Cl. H02K 7/02; H02K 1/27

(52) U.S. Cl. CPC H02K 7/025; H02K 1/272

(57) ABSTRACT

The present disclosure provides a device for storing energy, including: at least one electric machine, which is of the Lorentz generator or motor type and has a rotor and a stator, the rotor forming a flywheel; at least one magnet secured to the rotor; and at least one magnetic flux closure. The stator is wound and devoid of ferromagnetic material, and the magnetic flux closure is mounted such that it can move in synchronous rotation with the magnet of the rotor.

### CROSS-REFERENCE TO RELATED APPLICATIONS

This application is a continuation of International Application No. PCT/FR2014/050068, filed on Jan. 14, 2014, which claims the benefit of FR 13/50336, filed on Jan. 15, 2013. The disclosures of the above applications are incorporated herein by reference.

### FIELD

The present disclosure relates to a flywheel energy storage device.

### BACKGROUND

The statements in this section merely provide background information related to the present disclosure and may not constitute prior art.

A flywheel device is a device which enables storing and restoring energy that is stored in a kinetic form within a rotating mass.

Such devices are particularly used to smooth the operating speed of an electrical system and to make it more regular, whether the irregularities are due to the power supply source of the system or to the receiver using the energy.

Thus, they enable storing an energy surplus and then restoring it when the system lacks energy.

In particular, in the case of an electrical system, such devices may be used for example to adjust the frequency of a power grid, to stabilize the micro-grids or the smart grids or to avoid the occurrence of interruptions in order to provide a power supply without interruption.

In comparison with conventional energy storage devices, flywheel devices have advantages such as a longer service life, in particular in terms of charging and discharging cycles, a shorter response time, and a lower maintenance cost.

A flywheel device is generally constituted by an assembly comprising a suspended wheel and combined with an electric motor/generator, the rotor of which is connected to said wheel so as to form the flywheel. This assembly is generally placed in a vacuum-sealed enclosure, and the wheel is generally held suspended in a magnetic field and stabilized, within the meaning of the document FR 2 882 203, this configuration allows limiting the energy losses due to mechanical frictions.

Currently, flywheel devices have a limited efficiency insofar as they are equipped with motors/generators providing the conversion of electric energy into kinetic energy and conversely, on the one hand whose behavior may have a negative impact on the stability of the rotation of the flywheel, and on the other hand whose efficiency is low in that they have a significant self-discharge mainly due to frictions that occur at the flywheel and at the wound stator, such flywheels having a metallic core resulting in significant energy losses due to eddy currents and Joule effect in the motors/generators operating by magnetic repulsion.

The stability of the rotor also constitutes a major factor since any instability of the rotor has to be corrected or absorbed by the suspension bearings of the flywheel, which also results in energy loss. To this end, the electric machine should generate as little as possible axial or radial parasitic forces likely to destabilize the rotor.

### SUMMARY

The present disclosure improves the stability and the efficiency of flywheel devices. In one form, an energy storage device is provided that comprises:
a rotor forming the flywheel,
at least one Lorentz-type electric motor/generator comprising a rotor, a wound stator devoid of ferromagnetic material and at least one magnet fixed on a flywheel,
at least one means for closing the magnetic flux,
characterized in that the magnetic flux closing means is movably mounted in synchronic rotation with the magnet of the electric motor/generator.

It should be noted that such an energy storage device comprises a stator which does not have a metallic core, whether it is massive or laminated. More precisely, the magnetic flux closing means are only present on the rotor of the energy storage device.

Moreover, the motor/generator used is a Lorentz motor/generator (also called Laplace motor/generator), in other words in order to operate, such a motor/generator harnesses the Laplace force which is generally generated by a current-conducting wire passed through by an electric current presenting some intensity when the wire is subjected to an electromagnetic field. The generated Laplace force is orthogonal to the plane formed by the wire and the electromagnetic field.

By providing a synchronous rotation of the flux closing means with the rotor, the flux closure rotates synchronously with the inductive magnetic field of the rotor, the direction of the inductive magnetic field is and the intensity of the field along parasitic directions is significantly reduced.

Indeed, by using a fixed flux closure, the variations of the inductive magnetic flux result in corresponding variations therein.

These variations are not simultaneous due to the existence of a hysteresis cycle of the material constituting the flux closure, and there has been observed the formation of a magnetic field presenting parasitic components along undesirable directions.

Therefore, when the electric motor is powered and the stator develops a rotary magnetic field, the generated driving force presents also parasitic components, in particular along the radial and axial directions, which destabilize the rotor, and hence the flywheel.

This also results in an energy loss, mainly due to eddy currents. Thus, it is possible to use laminated sheets to form the means for closing the magnetic flux of the rotor in order to limit this effect.

By using a flux closure that rotates synchronously with the inductive magnetic field of the rotor, in accordance with the present disclosure, said flux closure is no longer subjected to variations of the magnetic field and remains exposed to the same local magnetic field.

The same applies when the storage device operates in the generator mode or in free rotation.

In this manner, the electric motor/generator presents few no-load losses, that is to say when it is not loaded while the rotor is rotating, and few no-load losses, that is to say when energy exchanges are taking place between the electric motor/generator and the outside during the charge or the discharge of the rotor forming the flywheel.

When the rotor is rotating without loading the electric motor/generator, there are no losses in the flux closure since the latter rotates synchronously with the inductive field of the magnets of the electric rotor.

When the electric motor/generator is loaded in the motor mode or in the generator mode, the flux density is provided by the magnets of the rotor and there are no energy losses at the inductor for creating the flux density.

As soon as rotary magnetic field created by the stator of the electric motor/generator is synchronous with the magnets and the flux closure, there are no losses due to eddy currents in the winding of the stator. Only possible harmonics are likely to be responsible for low losses in the rotating portion. At the first order, losses are limited to few Joule effect losses in the stator.

Hence, such a device allows limiting the energy losses at the electric motor/generator, the efficiency of the device is thereby significantly enhanced.

According to other features of the present disclosure, the energy storage device comprises several magnets fixed on the rotor forming the flywheel, and disposed according to a <<Klaus Halbach>> configuration, and the stator is disposed therearound facing the magnets and distant therefrom.

Advantageously, a <<Klaus Halbach>> configuration allows generating a strong focused magnetic field in a direction and a sense that are controlled.

According to one form of the present disclosure, the rotor comprises at least one flux closing means fixed on the rotor forming the flywheel, facing the magnets, distant from the stator, and on the side opposite to the magnets with respect to the stator.

According to another feature of the present disclosure, the magnets are fixed on a cylindrical portion of the rotor forming the flywheel. If appropriate, the flux closing means may be fixed on a thick wall of the rotor forming the flywheel.

Advantageously, the flux closing means can be integrated in the thick wall of the rotor so that they do not protrude from the thick wall.

Similarly, the magnets may be integrated in the cylindrical portion of the rotor so that they do not protrude from the cylindrical portion.

According to another form, the flux closing means is realized in the form of a strip brought on the flywheel.

According to another form of the present disclosure, the stator includes a multi-phase winding.

Advantageously, the arrangement of the phases of the stator can be adjusted so that the result of the radial forces of the electric motor/generator is either zero or self-centering and the result of the axial forces of the electric motor/generator is either zero or self-centering.

Such an arrangement of the phases of the stator allows providing the electric motor/generator with a neutral behavior as regards the stability of the rotation of the rotor forming the flywheel.

According to another feature of the present disclosure, the winding of the stator comprises a Litz wire.

The Litz wire, which consists of a wire constituted by elementary strands with a very thin section in the order of 0.1 mm diameter, and even lesser, allows a significant reduction of the losses resulting from eddy currents, in particular when the electric motor/generator is not loaded.

Advantageously, when the electric motor/generator is in the motor mode, the first order losses are limited to the Joule losses in the stator.

Advantageously, when the electric motor/generator is in the generator mode, the losses are strictly limited to the Joule losses in the stator and to the eddy currents losses in the strands of the Litz wires of the stator.

Advantageously, the stator is wound so as to improve the operation of the electric motor/generator while increasing the parasitic forces, that is to say, forces other than the Lorentz force.

According to one form of the present disclosure, the flux closing means are made of soft iron.

The hysteresis cycle of the soft iron is very narrow, which allows reducing the losses.

According to another form of the present disclosure, the rotor forming the flywheel comprises two Lorentz-type electric motors/generators mounted symmetrically and opposite to each other on either side of a mid-plane of the flywheel.

In this manner, this configuration allows for a better efficiency and for a better compensation of the forces, in particular axial forces, which can destabilize the rotor forming the flywheel since the axial forces generated by the rotation of the flywheel on either side of the mid-plane of the flywheel are symmetrical and opposite to each other with respect to this mid-plane of the flywheel.

Advantageously, the use of two electric motors/generators further allows enhancing the safety of the device to the extent that in a given configuration, if one of the electric motors/generators is not operational, this does not prevent the other from supplying energy to the rotor or retrieving it from the rotor so that the device continues fulfilling its charging and discharging task in order to maintain the stability of an electrical power grid or avoid interruptions so as to provide a power supply without interruption.

Another advantage consists of allowing, when both motors/generators are operational, to supply energy even more quickly than when only one Lorentz motor/generator is used.

According to another form of the present disclosure, the stators of the two electric motors/generators are connected in series.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic longitudinal sectional view of a rotor according to a first form of the present disclosure;

FIG. 2 is a schematic cross-sectional view of a rotor according to the first form of the present disclosure;

FIG. 3 is a schematic longitudinal sectional view of a rotor according to a second form of the present disclosure;

FIG. 4 shows an unwound view of the winding of the stator according to the second form of the present disclosure;

FIG. 5 is a schematic longitudinal sectional view of a rotor according to a third form of the present disclosure;

FIG. 6 is a perspective view of magnets in a <<Klaus Halbach>> configuration used for a fourth form of the present disclosure; and

FIG. 7 is a schematic longitudinal sectional perspective view of a rotor according to the fourth form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

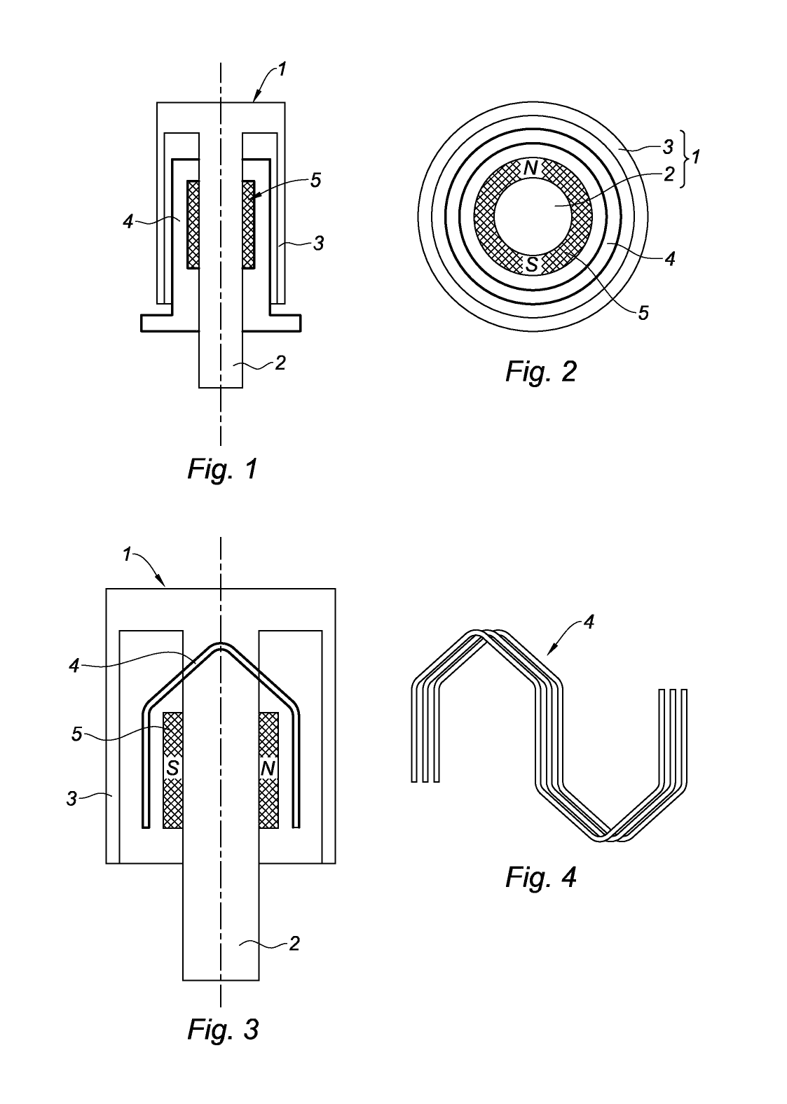

Referring to FIGS. 1 and 2, an energy storage device comprises:
a rotor 1 forming the flywheel comprising a cylindrical portion 2 and a thick wall 3 which are concentric and fixedly connected to one another and in a remote manner so as to form one single monolithic part. The cylindrical portion 2 and the thick wall 3 supporting a wheel (not represented) which may be made, for example, of a composite material, in particular carbon fibers.
a Lorentz-type electric motor/generator comprising the rotor 1, a stator 4 and a magnet 5. The magnet 5 is fixed on the cylindrical portion 2 of the rotor made of a ferromagnetic material, the thick wall 3 is constituted by a ferromagnetic material and is thus designed to constitute a means for closing the magnetic flux, the stator 4 is disposed between the cylindrical portion 2 and the thick wall 3.

Hence, the thick flux closing wall 3 is directly connected to the cylindrical portion 2 and driven with the same rotational movement.

In this manner, the flux closure is in synchronous rotation with the cylindrical portion 2 carrying the inductive magnets.

As exposed above, such a configuration allows canceling energy losses and parasitic forces likely to destabilize the rotation of the rotor 1 and which would be generated because of the magnetic hysteresis cycle of the material constituting the thick wall 3.

Thus, the energy losses are limited since there are no losses in the flux closure and the forces which destabilize the rotation of the rotor 1 are canceled.

Referring to FIGS. 3 and 4, there is the same configuration as in FIGS. 1 and 2 with the exception that the stator 4 is wound with Litz wires. Nonetheless, the stator 4 keeps the same arrangement as in FIGS. 1 and 2 with respect to the cylindrical portion 2 and to the thick wall 3.

In addition to presenting a magnetic flux closure rotating synchronously with the field generated by the magnet 5 of the electric motor/generator and therefore cancelling the losses in the magnetic flux closure, the device as is illustrated in FIGS. 3 and 4, presents a stator wound with Litz wires allowing considerably reducing the losses due to eddy currents.

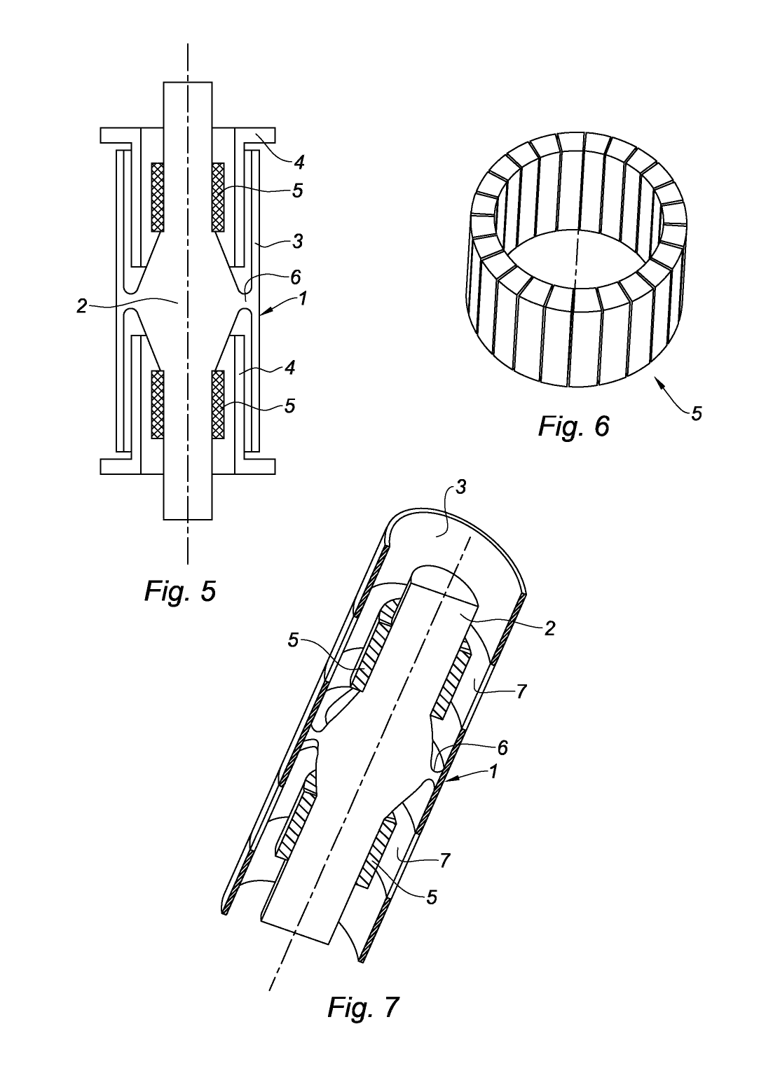

Referring to FIG. 5, the rotor 1 presents two Lorentz-type electric motors/generators disposed symmetrically with respect to the center of the cylindrical portion 2 of the rotor 1.

The configuration of the two motors/generators is substantially the same as in the previous figures, therefore presenting two magnets 5 (one for each electric motor/generator) and two stators 4.

In one form, the stators 4a and 4b are wound with a Litz wire.

The rotor 1 forming the flywheel is made so that a rim 6 fixedly connects the cylindrical portion 2 to the thick wall 3.

The rim 6 is shaped so as to be very stiff at its inner radius close to the cylindrical portion 2 in order not to be detached, and so as to be flexible at its outer radius close to the thick wall 3 in order to properly follow the deformations of the thick wall 3.

Several rims 6 may be used by being distributed along the cylindrical portion 2 and the thick wall 3 in order to provide a good connection between the cylindrical portion 2 and the thick wall 3.

In another form, the number of rims 6 to be used is determined depending on the resonance modes of the wheel in the considered speed range of the rotor 1.

This form allows to considerably reduce the energy losses, and to limit the self-discharge of the rotor thanks to a considerable reduction of the losses due to eddy currents and hysteresis, and a suppression of the parasitic forces which destabilize the rotation of the rotor 1. In addition, the use of two Lorentz-type electric motors/generators allows enhancing the stability, in particular the axial stability, of the rotation of the rotor 1.

Referring to FIGS. 6 and 7, the rotor 1 presents a configuration similar to the configuration of FIG. 5, namely two Lorentz-type electric motors/generators whose stators 4 are not represented.

The form disclosed in FIGS. 6 and 7 is different from that of FIG. 5 in that it comprises magnets disposed according to a <<Klaus Halbach>> configuration on the cylindrical portion 2 of the rotor 1 so as to form two <<Halbach cylinders>> 5 or <<magic cylinders>>, and in that the rotor 1 is made primarily in a non-ferromagnetic material. The magnetic flux closure is provided by two rings 7 made of a ferromagnetic material of the soft iron type, each ring being integrated in the structure of the thick wall 3 of the rotor 1 and disposed facing a Halbach cylinder.

This form allows to considerably reduce the energy losses, and to limit the self-discharge of the rotor.

It goes without saying that the present disclosure is not limited to the forms described above as examples but it encompasses all technical equivalents and variants of the described means as well as their possible combinations.

What is claimed is:

1. An energy storage device comprising:
a rotor forming a flywheel;
at least one Lorentz-type electric motor/generator comprising the rotor, a wound stator devoid of ferromagnetic material and at least one magnet fixed on the rotor; and
at least one means for closing a magnetic flux,
wherein the magnetic flux closing means is movably mounted in synchronous rotation with the magnet of the electric motor/generator.

2. The energy storage device according to claim 1, further comprising several magnets fixed on the rotor forming the flywheel, and disposed according to a <<Klaus Halbach>> configuration.

3. The energy storage device according claim 1, wherein the magnetic flux closing means is fixed on the rotor forming the flywheel, facing the magnets, and on an opposite side to the magnets with respect to the wound stator.

4. The energy storage device according to claim 1, wherein the magnetic flux closing means are realized in a form of a strip brought on the flywheel.

5. The energy storage device according to claim 1, wherein the wound stator comprises a multi-phase winding.

6. The energy storage device according to claim 1, wherein the winding of the wound stator comprises a Litz wire.

7. The energy storage device according to claim 1, wherein the magnetic flux closing means are made of soft iron.

8. The energy storage device according to claim 1, further comprising two Lorentz-type electric motors/generators.

9. The energy storage device according to claim 8, wherein the two Lorentz-type electric motors/generators are mounted symmetrically on either side of a mid-plane of the flywheel.

10. The energy storage device according to claim 8, wherein stators of the two electric motors/generators are connected in series.
